(19) United States
(12) Patent Application Publication
(10) Pub. No.: US 2017/0033846 A1
(43) Pub. Date: Feb. 2, 2017

(54) ESTIMATING BEAMFORMED MIMO CHANNEL PROPERTIES FROM NON-BEAMFORMED SOUNDINGS

(71) Applicant: QUALCOMM Incorporated, San Diego, CA (US)

(72) Inventors: Deniz Rende, San Jose, CA (US); Lawrence Winston Yonge, III, Summerfield, FL (US); Arun Avudainayagam, Fremont, CA (US); Hassan Kaywan Afkhami, San Jose, CA (US)

(21) Appl. No.: 14/810,194

(22) Filed: Jul. 27, 2015

(51) Int. Cl. H04B 7/04; H04B 7/06; H04B 7/08; H04L 5/00

(52) U.S. Cl. CPC H04B 7/0413; H04L 5/0048; H04L 5/006; H04B 7/0697; H04B 7/0617; H04B 7/08

(57) ABSTRACT

A method for determining transmission properties of a multiple-input multiple-output (MIMO) channel. In one embodiment, a MIMO receiver receives a non-beamformed, spatial-multiplexed (SM) sounding signal over multiple signal paths of the MIMO channel. The receiver determines beamforming information including beamforming coefficients and beamforming Eigenvalues for the MIMO channel based, at least in part, on frequency responses of the signal paths. The receiver determines a first signal-to-noise ratio (SNR) estimate for one or more SM data streams of the SM sounding signal based, at least in part, on the determined beamforming information.

### TECHNICAL FIELD

Embodiments of the disclosed subject matter generally relate to the field of beamformed Multiple-Input Multiple-Output (MIMO) communications, and more particularly to estimating signal-to-noise ratios (SNRs) of beamformed signals from non-beamformed soundings.

### BACKGROUND

Channel estimation and adaptation are used for optimizing communication reliability and throughput. For example, in powerline communication (PLC) systems, modems may support periodic channel estimation and adaptation based on channel conditions. Modems may use channel frequency responses and SNRs to estimate channel conditions.

Channel estimation and adaptation may be used in MIMO systems in which each channel comprises multiple signal paths. MIMO uses multiple signal paths between a transmitter and a receiver to provide enhanced capacity channels. MIMO has long been used for wireless communications. More recently, MIMO has been implemented in wireline communications, such as PLC. Spatial multiplexing is a modulation technique that may be utilized by MIMO communication systems. In a spatially multiplexed MIMO system, multiple distinct information streams are transmitted over different transmission paths.

Precoded spatial multiplexing (also known as beamforming or Eigen beamforming) can increase the reliability of a spatially multiplexed channel. Precoded spatial multiplexing may therefore increase data throughput. Beamforming (sometimes referred to as spatially multiplexed precoding or spatial filtering) is a signal processing technique for improving directional signal transmission or reception. Beamforming generally entails generating a focused signal transmission by shifting a signal in time (phase). Time shifting causes the signals to experience constructive or destructive interference at particular directions. Beamforming utilizes channel state information at the transmitter.

Known techniques for obtaining channel state and SNR feedback include training the transmitter using sounding signals, such as in the form of sounding packets, during channel estimation. While useful for obtaining channel state and SNR, the periodic use of sounding signals to maintain optimally adapted transmissions decreases overall transmission throughput.

### SUMMARY

A method for determining transmission properties of a MIMO channel is disclosed. In one embodiment, a MIMO receiver receives a non-beamformed, spatial-multiplexed (SM) sounding signal over multiple signal paths of the MIMO channel. The receiver may determine beamforming information including beamforming coefficients and beamforming Eigenvalues for the MIMO channel based, at least in part, on frequency responses of the signal paths. The receiver may also determine a first SNR estimate for one or more SM data streams of the SM sounding signal based, at least in part, on the determined beamforming information.

### BRIEF DESCRIPTION OF THE DRAWINGS

The present embodiments may be better understood, and numerous objects, and features made apparent to those skilled in the art by referencing the accompanying drawings.

FIG. 1 is a high-level block diagram depicting a communications network in accordance with one embodiment;

FIG. 2 is a block diagram illustrating PLC modems configured to establish beamformed communications over a MIMO channel in accordance with one embodiment;

FIG. 3 is a signaling diagram depicting a message flow between a transmitter and a receiver during MIMO channel estimation in accordance with one embodiment;

FIG. 4 is a flow diagram illustrating operations and functions for determining transmission properties of a MIMO channel in accordance with one embodiment; and

FIG. 5 depicts an example computer system for implementing the embodiments shown in FIGS. 1-4.

### DESCRIPTION OF EMBODIMENT(S)

The description that follows includes example systems, methods, techniques, instruction sequences and computer program products that embody techniques of the presently disclosed subject matter. However, it is understood that the described embodiments may be practiced without these specific details. In other instances, well-known instruction instances, protocols, structures and techniques have not been shown in detail in order not to obfuscate the description.

The disclosure describes techniques for determining MIMO channel transmission properties that can be used for beamformed transmissions. The transmission properties may include channel state information (CSI) and signal-to-noise ratios (SNRs). Some embodiments estimate beamformed signal SNRs from non-beamformed soundings. As disclosed herein, a MIMO receiver may receive, from a transmitter, a non-beamformed sounding signal as multiple spatial-multiplexed (SM) data streams. The SM data streams may be generated by the transmitter. The transmitter generates the SM data streams from one or more sounding packets containing known data. The receiver receives these streams over multiple signal paths of a MIMO channel during channel estimation. The receiver may determine frequency responses of the signal paths, and use the frequency responses to determine beamforming information including beamforming coefficients and beamforming Eigenvalues. The receiver may also use signal responses of the non-beamformed signals to determine non-beamformed SNR estimates for the SM data streams. The receiver can use the beamforming Eigenvalues to generate an SNR variation factor. The SNR variation factor may be applied to the non-beamformed SNR estimates to generate beamformed SNR estimates for the SM data streams. The receiver may utilize the beamformed SNR estimate(s) to determine bit loading values. The receiver may also generate a carrier tone map (also referred to as carrier modulation map) that incorporates the determined bit loading values. The receiver can transmit the beamforming coefficients and the carrier tone map to the transmitter. The transmitter may apply the beamforming coefficients and the carrier tone map to transmit beamformed data signals to the receiver. The receiver may apply an adaptation algorithm to the beamformed data signals to adjust the beamformed SNR estimate(s). The adjusted beamformed SNR estimates can be used to generate an updated carrier tone map which may be sent to the transmitter.

The receiver may utilize the beamforming Eigenvalues to determine whether to apply a positive or negative variation to the non-beamformed SNR estimates. In response to determining that a positive variation applies to a non-beamformed SNR estimate, the receiver increases a corresponding bit loading value by a specified amount. In response to determining that a negative variation applies to a non-beamformed SNR estimate, the receiver decreases a corresponding bit loading value by a specified amount.

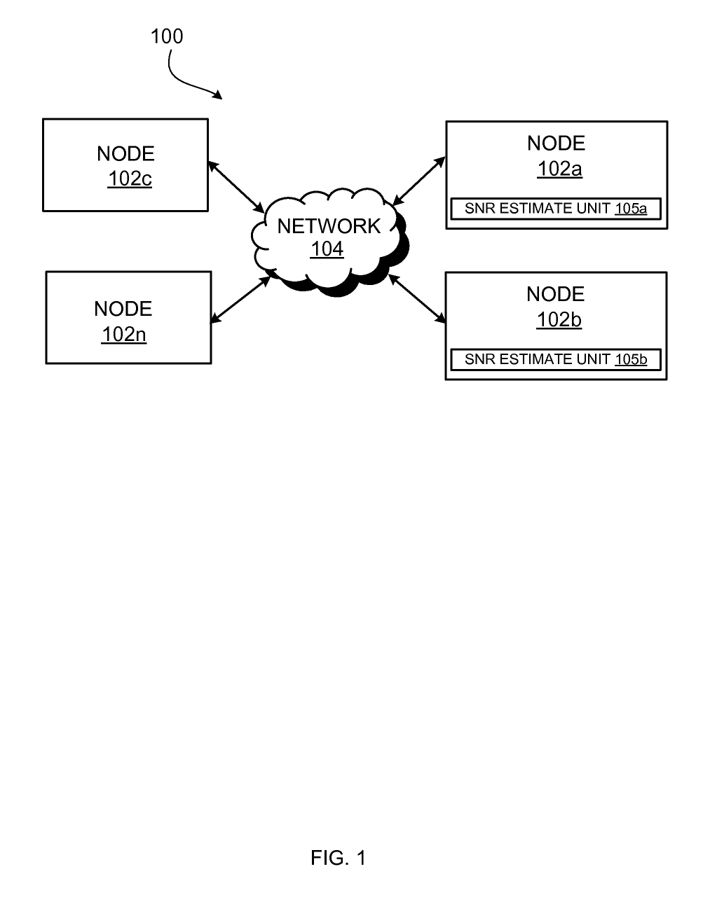

FIG. 1 shows an example communications network comprising multiple nodes that intercommunicate. A system 100 includes nodes 102a-102n intercommunicating over a network 104. The network 104 may include one or more different networking types. For example, the network 104 may include a local area network (LAN), such as a company intranet or home network. The network 104 may include one or more different types of transmission media, protocols, and data stream multiplexing (e.g., MIMO). For example, the network 104 may comprise wired LAN technologies that use physical transmission media, such as alternating current (AC) power lines used in PLC. The network 104 may also include wireless LAN technologies.

The topology of the network 104 may comprise one or more types and forms. For example, the topology of the network 104 may be configured to support point-to-point connections and/or broadcast connectivity. The topology of the network 104 may be a bus, star, ring, or any other topology capable of supporting the operations described herein.

The nodes 102a-102n may be nodes of a PLC network that communicate using any of a variety of communication protocols. For example, the nodes 102a-102n may utilize one of the HomePlug specifications, such as HomePlug AV2. Each node in the network 104 may communicate using a physical (PHY) layer protocol that is used to transmit data and sounding signals (e.g., network messages) to other nodes.

In some implementations, the nodes 102a-102n communicate using data units, such as network packets. The network packets may be transmitted over the air (wireless) or over power line cables, coaxial cables, phone wire media, etc. The network packets may include control information fields and may also include a data, or “payload” field. The payload field may include, for example, application data and/or higher layer protocol management information. The control information fields may include communication protocol, packet encoding and/or signal modulation information.

Each of the nodes 102a-102n may include one or more network interfaces comprising one or more networking architectures. For example, the networking architecture may be compliant with the Open Systems Interconnect (OSI) model. The networking architecture may include a PHY layer that can convert upper layer data structures to and from a signal waveform. The signal waveform may be transmitted over or received from the transmission medium of the network 104. For example, a PHY Protocol Data Unit refers to the modulated signal waveform representing a higher layer data unit. In one embodiment, the nodes 102a-102n may employ a multi-carrier PHY layer such as implemented by Orthogonal Frequency-Division Multiplexing (OFDM).

The PHY layers of one or more of the network interfaces may implement MIMO and spatial multiplexing to exploit multipath propagation. MIMO multiplies link capacity by using multiple transmit and receive antennas over which data can be transmitted and received in parallel. MIMO is a feature of several wireless communication standards, such as Institute of Electronics and Electrical Engineers (IEEE) 802.11n (Wi-Fi). MIMO has also been applied to powerline communication for 3-wire installations as part of ITU G.hn standard and HomePlug AV2 specification. Spatial multiplexing is a transmission technique that may be used for MIMO communication to transmit independent data streams of a common originating signal from each of the multiple transmit ports or antennas.

In one embodiment, the nodes 102a and 102b share a MIMO channel across the network 104. For example, the MIMO channel may be a 2×2 channel between the two transmit (TX) ports and the two receive (RX) ports. A 2×2 MIMO channel thus comprises four signal propagation paths (signal paths). Spatial multiplexing may be used for the MIMO channel configuration between nodes 102a and 102b. In spatial multiplexing, data is split into multiple streams. Each spatial-multiplexed (SM) data stream is transmitted from a different transmit port. In the 2×2 MIMO channel example, the first SM data stream is transmitted from the first TX port and the second SM data stream is transmitted from the second TX port. The two SM data streams then propagate through the four signal paths and a different mixture of the two SM data streams arrive on each of the two RX ports of the MIMO channel. The receive node processes the received signals on its RX ports to recover the SM data streams using estimates of the MIMO channel.

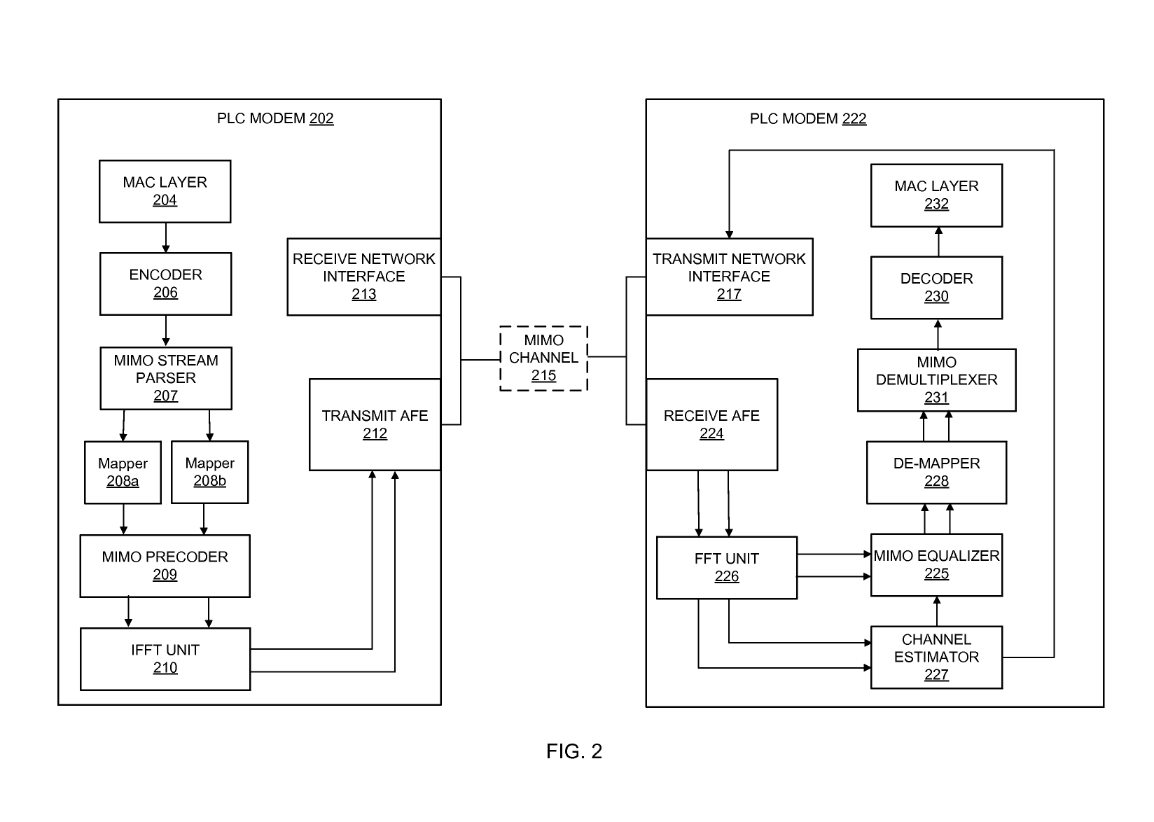

Spatial multiplexing increases channel capacity at higher SNRs, such as may be encountered in PLC transmissions. Furthermore, if CSI is available at a node's transmitter, spatial multiplexing can be combined with beamforming (sometimes referred to as Eigen beamforming). In beamforming, the SM data streams are precoded using beamforming coefficients, which are based on CSI. In the depicted embodiment, the nodes 102a and 102b may include SNR estimate units 105a and 105b, respectively. As described in further detail vis-à-vis FIGS. 2-4, the SNR estimate units 105a and 105b can be configured to estimate beamformed SNRs from non-beamformed sounding signals.

FIG. 2 is a block diagram illustrating PLC modems that may be included in one or more of the nodes in FIG. 1. The PLC modems 202 and 222 may be configured to establish beamformed communications over a MIMO channel 215. The PLC modems 202 and 222 may also be configured to communicate using OFDM modulation. Each of the PLC modems 202 and 222 can be included within a PLC adapter module that is a self-contained unit. The PLC adapter module may comprise an integrated power supply, a zero cross detector (for aligning transmissions relative to power line frequency), the PLC modem, and other components. The MIMO channel 215 incorporates a three-wire power line infrastructure medium to carry 2×2 MIMO transmissions between the PLC modems 202 and 222.

Modules within the PLC modem 202 that implement a transmit PHY layer may include an encoder 206 and a MIMO stream parser 207. The encoder 206 can receive media access control (MAC) protocol data units (MPDUs) from a MAC layer 204. The encoder 206 performs processing such as scrambling, error correction coding, and interleaving. The encoder 206 may encode bit segments of the MPDU data stream and sub-divide the encoded bit segments into a number of sub-segments.

The encoded, sub-segmented data is fed into the MIMO stream parser 207. The MIMO stream parser 207 may divide (e.g., multiplex) the data into two independent spatial-multiplexed (SM) data streams carried on two transmit paths. The MIMO stream parser 207 feeds each of the two SM data streams into respective mappers 208a and 208b. Each of the mappers 208a and 208b receives an SM data stream (including sub-segmented data) as grouped bits (e.g., 1, 2, 3, 4, 6, 8, or 10 bits), depending on the constellation used for the current OFDM symbol. Example constellations used for OFDM include Binary Phase Shift Keying (BPSK), Quadrature Phase Shift Keying (QPSK), 8-Quadrature Amplitude Modulation (QAM), 16-QAM, 64-QAM, 256-QAM, 1024-QAM and 4096-QAM constellations. The mappers 208a and 208b can map data values represented by the grouped bits into corresponding amplitudes of in-phase (I) and quadrature-phase (Q) components for the current symbol. For example, the mappers 208a and 208b may perform QAM encoding of the sub-segments to map the sub-segments into complex-valued points in a constellation pattern. The constellation pattern may also be referred to as a QAM constellation map, or simply a QAM constellation. Each complex-valued point in the QAM constellation may comprise a frequency domain sub-symbol representing discrete values of phase and amplitude.

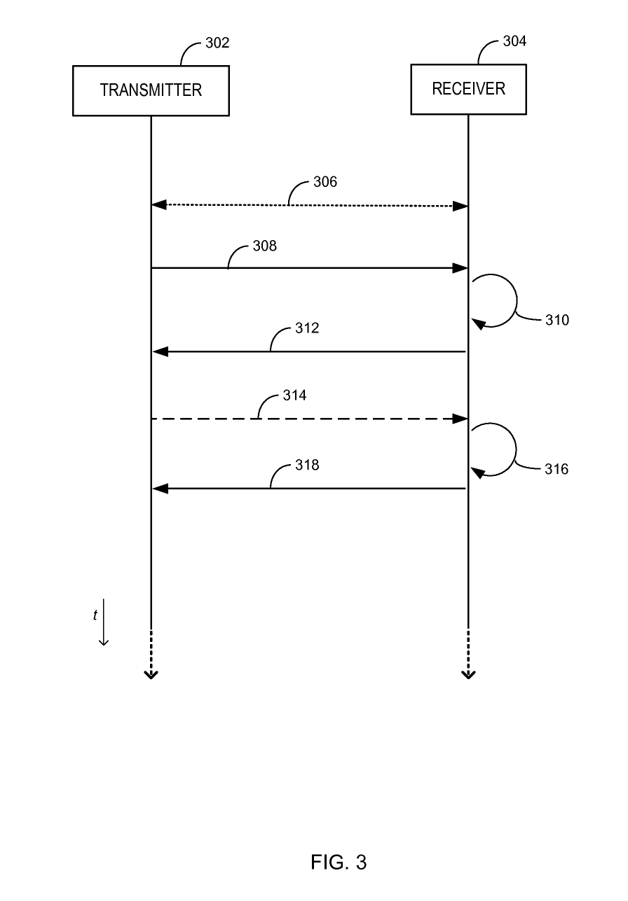

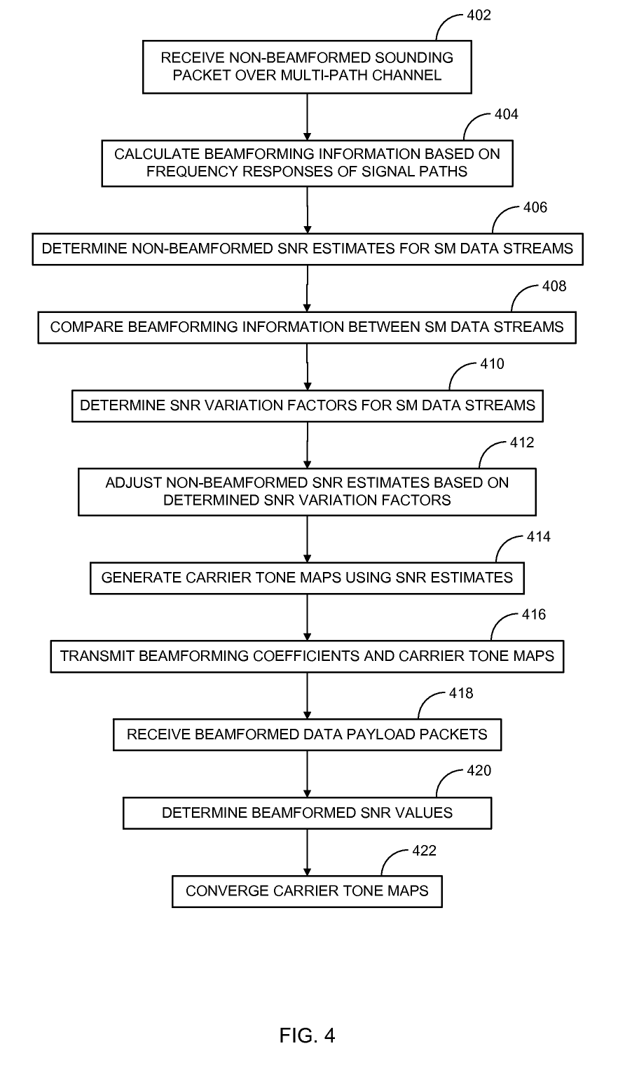

The mappers 208a and 208b may also determine the type and level of modulation to be used on each of the carriers (or “tones”). For example, and as explained in further detail below, the modulation levels may be determined based on carrier tone maps generated by PHY layer receive components within the PLC modem 222. The carrier tone maps may be received from the PLC modem 222 on a receive network interface 213 during channel estimation, as described in further detail below. The mapped SM data streams are fed from the mappers 208a and 208b to a MIMO precoder 209. During beamformed (i.e., non-sounding) communications, the MIMO precoder 209 performs beamforming operations on the SM data streams. For example, the MIMO precoder 209 may multiply the frequency domain symbols in each of the SM data streams by precoder matrices which are derived from the beamforming coefficients as described vis-à-vis FIGS. 3 and 4. By utilizing the precoder matrices, different combinations of the SM data streams are transmitted such that the receiver can more efficiently recover the two SM data streams. The MIMO precoder 209 may not apply beamforming during a non-beamformed sounding phase of channel estimation and may instead pass the two SM data streams without further processing.

For beamformed operations, the MEMO precoder 209 may pass beamformed signals as input to an Inverse fast Fourier Transform (IFFT) unit 210. The IFFT unit 210 may comprise two inverse discrete Fourier transform (IDFT) modules (not depicted), each configured to receive and process a respective one of the input beamformed signals. The IDFT modules can perform inverse fast Fourier transforms on the sequence of symbols in each of the signals, in this manner, the IFFT unit 210 may generate time-domain OFDM symbols consisting of in-phase and quadrature-shifted digital components for each of the signals.

The time-domain outputs from the IFFT unit 210 are fed into a transmit analog front-end (AFE) 212. The transmit AFE 212 comprises amplification, filtering, mixing, and two-port transmission components. The components within the transmit AFE 212 are configured to generate and couple analog signals containing a continuous-time version of the symbol sets of the beamformed signals over two ports to the MIMO channel 215. The MIMO channel 215 comprises two physical transmit media (i.e., wire pairs in PLC) that each carry a beamformed signal from the two transmit ports to two receiver ports. In one embodiment, the MIMO channel 215 is a 2×2 channel comprising four signal paths between the two transmit ports and two receive ports.

FIG. 2 further depicts receive PHY layer components in the PLC modem 222. The receive PHY layer components include a receive AFE 224, a Fast Fourier Transform (FFT) unit 226, and a MIMO equalizer 225. The receive AFE 224 may include two ports, each receiving one signal (received signal). Received signals contain a mixture of the beamformed transmit signals that are propagated through the four signal paths of the MIMO channel 215. The receive AFE may contain two parallel chains for processing the signals received on the two receive AFE ports. Each AFE chain may generate sampled signal data and timing information. The received signals on the two receive AFE chains are output as time-domain signals from the receive AFE 224 to the FFT unit 226. The FFT unit 226 may comprise two discrete Fourier transform (DFT) modules (not depicted). Each of the DFT modules may receive a respective one of the received time-domain signals and map the corresponding signal into corresponding frequency domain signal which are output to the MIMO equalizer 225 and a channel estimator 227. The channel estimator 227 uses the received frequency domain symbols for estimating a MIMO channel frequency response that corresponds to the signal paths of the MIMO channel. The MIMO channel frequency response is passed to the MIMO equalizer for recovering the two transmitted SM data streams. The MIMO channel frequency response is also used to calculate the beamforming information which may include beamforming coefficients and beamforming Eigenvalues. The MIMO equalizer 225 may use beamforming coefficients and the MIMO channel frequency response from the channel estimator 227 to recover the two transmitted SM data streams on the received frequency domain signals (from the FFT unit 226). The beamforming coefficients may be received from the channel estimator 227 which determines the beamforming information based on frequency responses of each of the four signal paths.

The MIMO equalizer 225 sends the recovered SM data streams to a de-mapper 228. The de-mapper 228 demodulates the frequency domain symbols in the two SM data streams into metrics for SM data bit streams (bit streams) and sends the demodulated SM bit streams to a MIMO de-multiplexer 231. The MIMO de-multiplexer 231 recombines the two SM bit streams and sends the recombined signal to a decoder 230. The decoder 230 decodes the bit streams including de-interleaving and descrambling to recover the data payload and send to a MAC layer 232 as MPDUs.

In one embodiment, the PLC modems 202 and 222 may communicate using beamformed transmissions to increase SNRs and corresponding data throughput. Such beamformed transmissions may be implemented by the Eigen beamforming mode described in the HomePlug AV2 specification. Beamforming entails precoding the signals carried on each of the MIMO signal paths based on transmission properties which may include CSI. CSI refers to determined channel properties resulting from, for example, interference, scattering, and power decay, that effect signal propagation from a transmitter to a receiver. CSI may include channel properties such as frequency response information from which beamforming information can be derived. Optimized beamformed transmissions may require determining SNRs as well as CSI. The CSI and SNR determinations may be performed during channel estimation. CSI and SNRs may be determined at the receiver (e.g., receive PHY layer of the PLC modem 222) during channel estimation, and may be quantified and fed back to the transmitter (e.g., transmit PHY layer of the PLC modem 202).

The PLC modems 202 and 222 may be configured to perform channel estimation. Metrics determined from channel estimation may include CSI, such as beamforming information and channel frequency responses for each of the MIMO channel signal paths. The channel estimation metrics may further include SNRs and/or carrier tone maps of each of the SM data streams. The channel estimation may include a packet sounding period in which the PLC modem 202 is the transmitter and the PLC modem 222 is the receiver. For example, the PLC modem 202 may transmit a sounding packet containing pre-specified (i.e., known to the PLC modem 222) data to the PLC modem 222 without beamforming (i.e., without processing by MIMO precoder 209). The signal paths received over the MIMO channel 215 may interfere at the receive AFE 224 and this interference is usually more severe without beamforming.

The PHY layer receive components of the PLC modem 222 use the known structure of the sounding packets and the received signal characteristics to estimate the channel frequency response (i.e., frequency responses of each of the signal paths). For example, while processing non-beamformed sounding packets, output from the FFT unit 226 may be received at the channel estimator 227. As described vis-à-vis FIGS. 3 and 4, the channel estimator 227 may process the non-beamformed signal information from the signal paths to determine CSI including signal path frequency responses. For example, the channel estimator 227 may determine the frequency responses of the signal paths corresponding to the data streams. The channel estimator 227 can then use the frequency responses to calculate the beamforming information including beamforming coefficients and beamforming Eigenvalues for the corresponding SM data streams. The CSI may also include SNR estimates for each of the SM data streams. For example, the channel estimator 227 may determine non-beamformed SNR estimates for each of the SM data streams. The channel estimator 227 may then adjust the non-beamformed SNR estimates based on the beamforming information to derive the beamformed SNR estimates.

After channel estimation, the receiving device (e.g., PLC modem 222) may determine and send PHY layer transmission properties to the transmitting device (e.g., PLC modem 202). The PHY layer transmission properties may include the beamforming coefficients and carrier tone maps. For example, the channel estimator 227 can utilize the SNR estimates to generate carrier tone maps for each of the SM data streams. The carrier tone map can includes channel adaptation information (e.g., modulation, coding rate, error correction, etc.) for the carrier frequencies on each SM data stream. The channel estimator 227 may transmit the carrier tone maps and beamforming coefficients to the transmit components of the PLC modem 202 via a transmit network interface 217.

FIG. 3 is a message flow diagram depicting communications and operations performed by a transmitter and receiver during channel estimation. In FIG. 3, a flow diagram 300 shows a transmitter 302 and a receive 304 that communicate using SM data streams. At 306, the transmitter 302 and receiver 304 are coupled via a MIMO channel that carries SM data streams over multiple signal paths. At 308, the transmitter 302 transmits a non-beamformed sounding signal to the receiver 304. The sounding signal is carried across a MIMO channel (not depicted) as multiple signal path components. At 310, the receiver 304 measures and processes the signal path components of the non-beamformed signal streams to determine transmission properties of the MIMO channel. For example, the receiver may measure the frequency responses on each of the signal paths to calculate beamforming information including beamforming Eigenvalues and beamforming coefficients (components of beamforming Eigenvectors) for the MIMO channel. The receiver 304 may further compare received and demodulated (i.e., equalized) QAM constellations with transmitted QAM constellations to determine non-beamformed SNR estimates for each of the SM data streams. The non-beamformed SNR estimates may be determined as per-carrier SNR values for each of the SM streams.

At 310, the receiver 304 may also use the non-beamformed SNR estimates and the beamforming information to determine SNR estimates for each of the SM data streams. For example, and as described vis-à-vis FIG. 4, the receiver 304 may determine an SNR variation factor for at least one of the SM data streams based on a comparison of the beamforming Eigenvalue of one SM data stream with the beamforming Eigenvalue of another SM data stream. The receiver 304 may apply the SNR variation factors to one or more of the non-beamformed SNR estimates to generate SNR estimates for one or more of the SM data streams. The SNR estimates can then be used to determine various parameters, such as the type and level of modulation to be used by the transmitter 302. For example, the receiver 304 may generate carrier tone map information based on the SNR estimates.

The beamforming coefficients and carrier tone map information may be sent collectively as an extended tone map message (shown at 312) to the transmitter 302. The beamforming coefficient data may be incorporated into a tone map configuration message. Alternatively, the beamforming coefficient data may be included as a separate portion of a configuration message that includes both carrier tone map data and beamforming coefficient data. As another alternative, the beamforming coefficient data may be transmitted as a separate configuration message.

Subsequent transmissions from the transmitter 302 may utilize the transmission properties from the received beamforming coefficients and carrier tone maps. At 314, following receipt and processing of the beamforming coefficients and carrier tone map information, channel estimation may end with the transmitter 302 transmitting one or more data payload packets (i.e., non-sounding packets). For example, the transmitter 302 may transmit a data payload packet that is beamformed based on the received beamforming coefficients. Further, the beamformed packet's modulation level, including power and bit loading, is set in accordance with the received SNR estimates.

At 316, the receiver 304 may process the beamformed data payload packet(s) to determine a beamformed SNR value. For example, the receiver 304 may compare received and demodulated QAM constellations with transmitted QAM constellations to determine beamformed SNR values for each of the SM data streams. The receiver 304 may then use the beamformed SNR values to modify or generate new carrier tone maps to be transmitted to the transmitter at 318.

FIG. 4 is a flow diagram illustrating operations for determining transmission properties of a MIMO channel. The operations in FIG. 4 can be performed, for example, by a receive node during channel estimation. One or more of the steps may be performed by a receive node, such as the PHY layer receive components of the PLC modem 222 in FIG. 2. The process begins at block 402 with a receiver receiving one or more non-beamformed sounding packets over multiple signal paths of the MIMO channel. At block 404, the receiver may measure frequency responses for two or more of the signal paths and calculate beamforming information based on the frequency responses. For example, in the 2×2 MIMO configuration of the MIMO channel 215, the receiver may measure the frequency responses of each of four signal paths corresponding to signal propagation paths for the two SM data streams over the 2×2 MIMO channel. The beamforming information may include beamforming coefficients and beamforming Eigenvalues for each of the SM data streams.

The frequency responses may be characterized by the expression: y=Hx+n and x=Wu, where y corresponds to the received beamformed signal and H corresponds to the channel frequency response. Furthermore, n corresponds to receive port noise, and x corresponds to the beamformed transmit signal. W corresponds to the beamforming matrix, and u corresponds to the input transmit signals. In such a configuration, the channel frequency response values (H) comprises frequency response values for each of the signal paths in the MIMO channel. The beamforming matrix (W) comprises beamforming coefficients for each of the SM data streams.

In one embodiment, the receiver also determines non-beamformed SNR estimates for each of the SM data streams (block 406). For example, the non-beamformed SNR values may be calculated based on comparisons of QAM constellations between the received and transmitted signals. Furthermore, the SNR estimates for each SM data stream may comprise SNR values corresponding to carrier frequencies for each of the respective SM data streams (i.e., carrier SNRs). Next, at blocks 408-412, the receiver may commence an SNR estimate process. In one embodiment, the receiver compares the beamforming information for each of the SM data streams (block 408). For example, the receiver may compare the beamforming Eigenvalue of one SM data stream with the beamforming Eigenvalue of another SM data stream. At block 410, the receiver can determine one or more SNR variation factors based, at least in part, on the comparison(s) at block 408. Next, the receiver may adjust (i.e., increase or decrease) the non-beamformed SNR values based, at least in part, on the SNR variation factors (block 412). For example, the beamforming information comparison at block 408 may reveal a differential between the beamforming Eigenvalues of two SM streams (i.e., differential between respective Eigenvalues). The differential may be used by the receiver to determine an increment (variation factor) by which to increase or decrease the determined non-beamformed SNRs for one or both of the data streams. The adjustment at block 412 results in SNR estimates for each of the respective data streams.

At block 414, the receiver may generate carrier tone maps for one or more of the SM streams based on the SNR estimates. For example, the SNR estimates may be used to determine a bit loading (i.e., bit rate) value that may be used, in part, to generate the carrier tone map. Next, the receiver may transmit channel state information including the beamforming coefficients and the carrier tone maps to the transmitter that sent the non-beamformed sounding packet(s) (block 416). Sounding may terminate with the transmitter receiving and processing the channel state information. At block 418, the transmitter may commence beamformed communications by applying the beamformed coefficients to beamform and transmit data streams received on at least two signal paths by the receiver. At block 420, the receiver may determine SNR values of the beamformed data streams to generated beamformed SNR values which may be used to modify the carrier tone maps (block 422). The modified carrier tone maps may then be fed back to the transmitter to achieve optimal beamformed MIMO transmission quality.

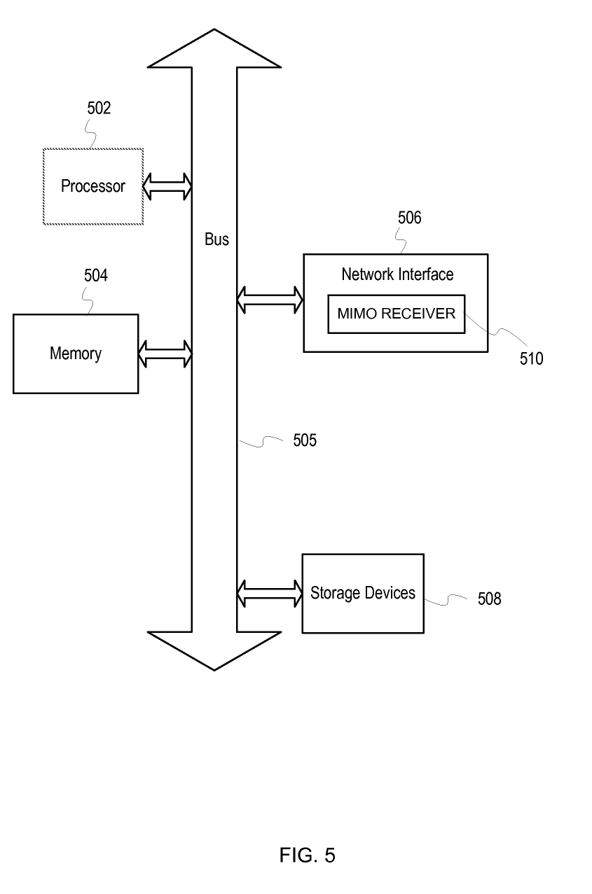

FIG. 5 depicts an example computer system having a MIMO receiver within a network interface. The network interface 506 may be PLC interface, an Ethernet interface, a Frame Relay interface, synchronous optical networking (SONET) interface, wireless interface, etc. The computer system includes a processor 502 (possibly including multiple processors, multiple cores, multiple nodes, and/or implementing multi-threading, etc.). The computer system includes memory 504 which may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of non-transitory machine-readable storage media. The computer system also includes an interconnect 505 (e.g., PCI, ISA, PCI-Express, HyperTransport®, InfiniBand®, NuBus, etc.) and a storage device(s) 508 (e.g., optical storage, magnetic storage, etc.).

The MIMO receiver 510 includes components (e.g., hardware, instructions, etc.) to implement functionality described above with reference to FIGS. 1-4. The MIMO receiver 510 may perform operations that facilitate MIMO channel estimation including operations for configuring a MIMO channel for beamformed communications. These operations may be partially (or entirely) implemented in hardware and/or on processor 502. For example, the functionality may be implemented with an application specific integrated circuit, in logic implemented in processor 502, in a co-processor on a peripheral device or card, etc. Further, realizations may include fewer or additional components not illustrated in FIG. 5 (e.g., additional network interfaces, peripheral devices, etc.).

As will be appreciated by one skilled in the art, aspects of the disclosed subject matter may be embodied as a system, method or computer program product. Accordingly, embodiments of the disclosed subject matter may take the form of an entirely hardware embodiment, an entirely software embodiment (including firmware, resident software, micro-code, etc.) or an embodiment combining software and hardware aspects that may all be referred to herein as a “circuit,” “module,” or “system.” Furthermore, embodiments of the disclosed subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

It should be understood that FIGS. 1-5 are examples meant to aid in understanding embodiments and should not be used to limit embodiments or limit scope of the claims. Embodiments may perform additional operations, fewer operations, operations in a different order, operations in parallel, and some operations differently. In some embodiments, a MIMO receiver can implement the operations of FIGS. 3 and 4 individually or in combination.

What is claimed is:

1. A method for determining transmission properties of a multiple-input multiple-output (MIMO) channel, said method comprising:
receiving a spatial-multiplexed (SM) sounding signal over multiple signal paths of the MIMO channel;
determining beamforming information for the MIMO channel based, at least in part, on frequency responses of the signal paths; and
determining a first signal-to-noise ratio (SNR) estimate for a first SM data stream of the SM sounding signal based, at least in part, on the determined beamforming information.

2. The method of claim 1, wherein the first SNR estimate comprises SNR values corresponding to carrier frequencies for the first SM data stream.

3. The method of claim 1, further comprising:
determining a bit loading value based, at least in part, on the first SNR estimate; and
generating a carrier tone map for the first SM data stream based, at least in part, on the determined bit loading value.

4. The method of claim 1, wherein said determining the first SNR estimate comprises:
determining a first non-beamformed SNR estimate based on a signal response of the first SM data stream;
determining an SNR variation factor for the first SM data stream based, at least in part, on the determined beamforming information; and
adjusting the first non-beamformed SNR estimate based, at least in part, on the determined SNR variation factor.

5. The method of claim 1, further comprising determining a second SNR estimate for a second SM data stream based, at least in part, on the determined beamforming information.

6. The method of claim 5, wherein said determining beamforming information for the MIMO channel comprises determining beamforming information for the first and second SM data streams based, at least in part, on frequency responses of the signal paths.

7. The method of claim 6, wherein said determining the first and second SNR estimates comprises:
determining a first non-beamformed SNR estimate based on a signal response corresponding to the first SM data stream;
determining a second non-beamformed SNR estimate based on a signal response corresponding to the second SM data stream;
comparing beamforming information for the first SM data stream with beamforming information for the second SM data stream;
determining an SNR variation factor for at least one of the first and second SM data streams based, at least in part, on said comparing the beamforming information for the first SM data stream with the beamforming information for the second SM data stream; and
adjusting at least one of the first and second non-beamformed SNR estimates based, at least in part, on the determined SNR variation factor.

8. The method of claim 7, wherein said determining beamforming information for the first and second SM data streams comprises determining a beamforming Eigenvalue for the first SM data stream and a beamforming Eigenvalue for the second SM data stream.

9. The method of claim 8, wherein said comparing beamforming information for the first SM data stream with beamforming information for the second SM data stream comprises comparing the beamforming Eigenvalue for the first SM data stream with the beamforming Eigenvalue for the second SM data stream.

10. The method of claim 8, wherein said determining the first and second SNR estimates comprises:
determining a differential between the beamforming Eigenvalue for the first SM data stream and the beamforming Eigenvalue for the second SM data stream;
increasing the first non-beamformed SNR estimate based, at least in part, on the determined differential; and
decreasing the second non-beamformed SNR estimate based, at least in part, on the determined differential.

11. A MIMO receiver for determining transmission properties of a multiple-input multiple-output (MIMO) channel, said MIMO receiver comprising:
an analog front-end that receives a spatial-multiplexed (SM) sounding signals over multiple signal paths of the MIMO channel; and
a channel estimator configured to,
determine beamforming information for the MIMO channel based, at least in part, on frequency responses of the signal paths; and
determine a first signal-to-noise ratio (SNR) estimate for a first SM data stream of the SM sounding signal based, at least in part, on the determined beamforming information.

12. The MIMO receiver of claim 11, wherein the first SNR estimate comprises SNR values corresponding to carrier frequencies for the first SM data stream.

13. The MIMO receiver of claim 11, wherein the channel estimator is further configured to:
determine a bit loading value based, at least in part, on the first SNR estimate; and
generate a carrier tone map for the first SM data stream based, at least in part, on the determined bit loading value.

14. The MIMO receiver of claim 11, wherein said channel estimator is further configured to:
determine a first non-beamformed SNR estimate based on a signal response of the first SM data stream;
determine an SNR variation factor for the first SM data stream based, at least in part, on the determined beamforming information; and
adjust the first non-beamformed SNR estimate based, at least in part, on the determined SNR variation factor.

15. The MIMO receiver of claim 11, wherein the channel estimator is further configured to determine a second SNR estimate for a second SM data stream based, at least in part, on the determined beamforming information.

16. The MIMO receiver of claim 15, wherein the channel estimator is further configured to determine beamforming information for the first and second SM data streams based, at least in part, on frequency responses of the signal paths.

17. The MIMO receiver of claim 16, wherein the channel estimator is further configured to:
determine a first non-beamformed SNR estimate based on a signal response corresponding to the first SM data stream;
determine a second non-beamformed SNR estimate based on a signal response corresponding to the second SM data stream;
compare beamforming information for the first SM data stream with beamforming information for the second SM data stream;
determine an SNR variation factor for at least one of the first and second SM data streams based, at least in part, on said comparing the beamforming information for the first SM data stream with the beamforming information for the second SM data stream; and
adjust at least one of the first and second non-beamformed SNR estimates based, at least in part, on the determined SNR variation factor.

18. The MIMO receiver of claim 17, wherein the channel estimator is further configured to determine a beamforming Eigenvalue for the first SM data stream and a beamforming Eigenvalue for the second SM data stream.

19. The MIMO receiver of claim 18, wherein said comparing beamforming information for the first SM data stream with beamforming information for the second SM data stream comprises comparing the beamforming Eigenvalue for the first SM data stream with the beamforming Eigenvalue for the second SM data stream.

20. The MIMO receiver of claim 18, wherein the channel estimator is further configured to:
determine a differential between the beamforming Eigenvalue for the first SM data stream and the beamforming Eigenvalue for the second SM data stream;
increase the first non-beamformed SNR estimate based, at least in part, on the determined differential; and
decrease the second non-beamformed SNR estimate based, at least in part, on the determined differential.

21. A non-transitory machine-readable storage medium having machine executable instructions stored therein, the machine executable instructions for determining transmission properties of a multiple-input multiple-output (MIMO) channel, the machine executable instructions comprising instructions that when executed by a processor, cause the processor to:
receive a spatial-multiplexed (SM) sounding signal over multiple signal paths of the MIMO channel;
determine beamforming information for the MIMO channel based, at least in part, on frequency responses of the signal paths; and
determine a first signal-to-noise ratio (SNR) estimate for a first SM data stream of the SM sounding signal based, at least in part, on the determined beamforming information.

22. The non-transitory machine-readable storage medium of claim 21, wherein the machine executable instructions further comprise instructions that when executed by the processor, cause the processor to:
determine a bit loading value based, at least in part, on the first SNR estimate; and
generate a carrier tone map for the first SM data stream based, at least in part, on the determined bit loading value.

23. The non-transitory machine-readable storage medium of claim 21, wherein the machine executable instructions further comprise instructions that when executed by the processor, cause the processor to:
determine a first non-beamformed SNR estimate based on a signal response of the first SM data stream;
determine an SNR variation factor for the first SM data stream based, at least in part, on the determined beamforming information; and
adjust the first non-beamformed SNR estimate based, at least in part, on the determined SNR variation factor.

24. The non-transitory machine-readable storage medium of claim 21, wherein the machine executable instructions further comprise instructions that when executed by the processor, cause the processor to determine a second SNR estimate for a second SM data stream based, at least in part, on the determined beamforming information.

25. The non-transitory machine-readable storage medium of claim 24, wherein the machine executable instructions further comprise instructions that when executed by the processor, cause the processor to determine beamforming information for the first and second SM data streams based, at least in part, on frequency responses of the signal paths.

26. The non-transitory machine-readable storage medium of claim 25, wherein the machine executable instructions further comprise instructions that when executed by the processor, cause the processor to:
determine a first non-beamformed SNR estimate based on a signal response corresponding to the first SM data stream;
determine a second non-beamformed SNR estimate based on a signal response corresponding to the second SM data stream;
compare beamforming information for the first SM data stream with beamforming information for the second SM data stream;
determine an SNR variation factor for at least one of the first and second SM data streams based, at least in part, on said comparing the beamforming information for the first SM data stream with the beamforming information for the second SM data stream; and
adjust at least one of the first and second non-beamformed SNR estimates based, at least in part, on the determined SNR variation factor.

27. The non-transitory machine-readable storage medium of claim 26, wherein the machine executable instructions further comprise instructions that when executed by the processor, cause the processor to determine a beamforming Eigenvalue for the first SM data stream and a beamforming Eigenvalue for the second SM data stream.

28. The non-transitory machine-readable storage medium of claim 27, wherein the machine executable instructions further comprise instructions that when executed by the processor, cause the processor to compare the beamforming Eigenvalue for the first SM data stream with the beamforming Eigenvalue for the second SM data stream.

29. The non-transitory machine-readable storage medium of claim 27, wherein the machine executable instructions further comprise instructions that when executed by the processor, cause the processor to:
determine a differential between the beamforming Eigenvalue for the first SM data stream and the beamforming Eigenvalue for the second SM data stream;
increase the first non-beamformed SNR estimate based, at least in part, on the determined differential; and
decrease the second non-beamformed SNR estimate based, at least in part, on the determined differential.

30. A system for determining transmission properties of a multiple-input multiple-output (MIMO) channel, said system comprising:
means for receiving a spatial-multiplexed (SM) sounding signal over multiple signal paths of the MIMO channel;
means for determining beamforming information for the MIMO channel based, at least in part, on frequency responses of the signal paths; and
means for determining a first signal-to-noise ratio (SNR) estimate for a first SM data stream of the SM sounding signal based, at least in part, on the determined beamforming information.
